(19) United States
(12) Patent Application Publication
(10) Pub. No.: US 2024/0025257 A1
(43) Pub. Date: Jan. 25, 2024

(54) METHOD FOR OPERATING A VEHICLE INFORMATION SYSTEM

(71) Applicant: AUDI AG, Ingolstadt (DE)

(72) Inventors: Jürgen LERZER, Neumarkt (DE); Christoph DALKE, Kipfenberg (DE); Thomas JUNGE, Gaimersheim (DE); Daniel ENDRES, Adelsried (DE)

(73) Assignee: AUDI AG, Ingolstadt (DE)

(21) Appl. No.: 18/003,722

(22) PCT Filed: Jun. 7, 2021
(86) PCT No.: PCT/EP2021/065094

§ 371 Date: Dec. 29, 2022

(30) Foreign Application Priority Data
Jun. 29, 2020 (DE) 10 2020 116 988.4

(51) Int. Cl. B60K 37/06

(52) U.S. Cl. CPC B60K 37/06; B60K 2370/1438; B60K 2370/149

(57) ABSTRACT

A method of operating an information system of a vehicle, in which a processor subsystem of a system on a chip (SoC) of the information system of the vehicle executes a system partition of the SoC and a vehicle infotainment partition (IVI) of the SoC. A functional system of the system partition produces a graphical operating element and locates the graphical operating element in a composition plane of a main compositor of the information system, which plane is at the front relative to a user's sight line. A touch-sensitive display screen which is functionally connected to the SoC is arranged centrally in the vehicle to display a display content which is provided by the main compositor and includes the graphical operating element. The described examples relate to an information system for a vehicle.

### CROSS-REFERENCE TO RELATED APPLICATIONS

This application is a U.S. national stage of International Application No. PCT/EP2021/065094, filed on Jun. 7, 2021, which International Application claims the priority benefit of German Application No. 10 2020 116 988.4 filed on Jun. 29, 2020. Both the International Application and the German Application are incorporated by reference herein in their entirety.

### BACKGROUND

### 1. Field

An aspect of described examples of the invention relates to a method for operating an information system of a vehicle in which a processor subsystem (central processing unit, CPU) of a system on a chip (SoC) of an information system of a vehicle, executes a system partition of the SoC and an in-vehicle infotainment (IVI) partition of the SoC. A functional system of the system partition generates a graphical operating element and arranges the graphical operating element in a front composition plane of a master compositor of the information system relative to a line of vision of a user, and a touch-sensitive display screen (center infotainment display, CID) of the information system which is functionally connected to the SoC and is arranged centrally in the vehicle displays a display content which is provided by the master compositor and includes the graphical operating element. The described examples related to an information system for a vehicle.

### 2. Description of Related Art

Information systems for vehicles are known in various forms in the prior art and serve to display information which a vehicle provides for a user of the vehicle, i.e. for a driver or a vehicle occupant other than the driver.

The information to be displayed generally comprises graphical output generated by functional systems of the vehicle which must have high safety relevance, substantial robustness to faults and early availability once the vehicle is switched on, and in many cases must meet prescribed functional safety requirements. The graphical output of functional systems includes, for example, power-on animation, a system pop-up, a climate control system operating interface, a personalization module, a cockpit display and the like.

The information to be displayed generally further comprises graphical outputs which are generated by information systems and entertainment systems of the vehicle and serve to provide information or entertainment for the user, are referred to as in-vehicle infotainment (IVI) systems and are primarily intended to create a pleasant user experience (UX) and offer a wide variety of possible uses. Information and entertainment systems of the vehicle which generate graphical infotainment elements include, for example, a navigation system, a radio, a telephone, an Internet browser, a multimedia system and an application for connecting to external devices, such as, for example, for the integration of a smartphone.

The functional systems of the vehicle and the information and entertainment systems of the vehicle can be designed as a system on a chip (SoC) with a system partition comprising the functional systems of the vehicle and an in-vehicle infotainment partition, IVI partition for short, comprising the information and entertainment systems, IVI systems for short, of the vehicle, and a processor subsystem (central processing unit, CPU) to execute the system partition and the IVI partition. The system on a chip can be comprised of the information system.

The information system can also include a display screen (center infotainment display, CID) which is functionally connected to the system on a chip and is arranged centrally in the vehicle which is usually designed as touch-sensitive and primarily for displaying a graphical output generated by an IVI system, IVI output for short, and for actuating the functional systems and the IVI systems. However, a need often exists to display a graphical output generated by a functional system, a system output for short, on the central display screen together with the IVI output during the operation of the information system.

The user can select an operating element of a graphical output displayed on the display screen by touching the central display screen, for example with a finger, and can initiate a function assigned to the graphical operating element. DE 10 2014 111 749 A1 thus discloses an information system for a vehicle and a method for operating the information system. A number of touch points of one or more fingers and a movement of the number of touch points are detected by a touch-sensitive display screen arranged centrally in the vehicle. A function is selected on the basis of the number of touch points and a gesture is identified on the basis of the movement of the number of touch points and the selected function is initiated depending on the detected gesture.

The common display of a plurality of graphical outputs can be implemented in a plurality of disjoint sections of a display area of the central display screen. It may be desirable to adjust the size of the sections manually according to the graphical outputs. DE 10 2012 022 312 A1 discloses an information system of this type for a vehicle and a method for operating the information system. Two different graphical outputs are displayed on a touch-sensitive display screen of the information system alongside one another in two sections of the display screen separated from one another by a line. A user can move the vertical line in a transverse direction by means of a manual touch gesture in order to enlarge or reduce areas of the two sections and create more or less space for the respective graphical outputs.

However, the common display on the central display screen of graphical outputs which are generated, on one hand, by functional systems and, on the other hand, by IVI systems creates further problems.

First of all, a function or visibility of a graphical output generated by the system partition can be impeded by a graphical output generated by the IVI partition. The impediment could be counteracted by means of error detection logic (watchdog logic) which brings the system output to the foreground if required in such a way that the IVI output is at least partially masked. However, the user experience created by the IVI output would then be adversely affected and the complexity of the information system increased.

A section of the display screen freed up by a system output and usable for displaying an IVI output can further be inadequate. A video stream, for example, conventionally formatted in the standardized 16:9 aspect ratio can only be displayed as inadequately small. Furthermore, an input method editor (IME) which simulates a keyboard cannot free up an adequate display area for search results. Furthermore, in an example, an IVI application which uses an immersive mode (available from ANDROID 4.4) for IVI application's graphical outputs is restricted by the graphical outputs of the system partition.

Moreover, compatibility of third-party applications with an IME provided by an original equipment manufacturer (OEM) cannot be guaranteed. Only with complete compatibility could the IME of the original equipment manufacturer as the sole application of the IVI partition be allowed to mask a system output.

### SUMMARY

Described is an improved method for operating an information system of a vehicle which is simple to implement and operate and guarantees both a pleasant user experience created by IVI outputs and a function and visibility of system outputs. In addition, according to described examples, an information system for a vehicle may be provided.

In an example, a method for operating an information system of a vehicle is provided in which a processor subsystem of the system on a chip of an information system of the vehicle executes a system partition of the system on a chip and an in-vehicle infotainment partition system of the system on a chip. A functional system of the system partition generates a graphical operating element and arranges it in a front composition plane of a master compositor of the information system relative to a line of vision of a user of the vehicle, and a touch-sensitive display screen of the information system which is functionally connected to the system on a chip and is arranged centrally in the vehicle, displays a display content which is provided by the master compositor and comprises the graphical operating element. Operating methods of this type are carried out by vehicle information systems of many modern vehicles so that a wide variety of possible uses may exist.

The graphical operating element is understood to mean a graphical element to which, in particular, a touch area of the display screen having an identical position and identical contour and a function are assigned, wherein the system partition initiates said function as a result of a manual touching of the touch area by the user. The display content is shown by the display screen over the entire display screen area, i.e. an outer contour and number of pixels of the display content are equal to an outer contour and number of pixels of the display screen.

In the method according to an example, the system partition minimizes or maximizes the graphical operating element following a switchover event generated outside the system partition. A minimization is understood to mean a transformation into a minimized state, i.e. a reduction of the graphical operating element. A maximization accordingly means a transformation into a maximized state, i.e. an enlargement of the graphical operating element.

The minimized graphical operating element is small in size relative to a display area of the display screen and masks a small area of rear composition planes of the master compositor. Consequently, graphical elements arranged in rear composition planes of the master compositor can essentially be displayed by the display screen over the entire display screen area. However, the small size of the operating element is sufficient to initiate a single function assigned to the minimized operating element through a manual touch.

Conversely, a plurality of disjunct touch areas can be assigned to the maximized graphical operating element, and different functions can be assigned in each case to the touch areas, said functions being initiated by a manual touching of the respective touch area. The maximized graphical operating element can advantageously comprise the minimized graphical operating element, i.e. the graphical operating element can be an enhancement of the minimized graphical operating element.

In particular, the maximized graphical operating element for its part can have one or more transient enhancements (flyouts), i.e. the transient enhancements are shown for a predetermined time duration from the maximization and fade out after the predetermined time duration.

In an example, an infotainment system of the in-vehicle infotainment partition generates a graphical infotainment element and arranges the graphical infotainment element in a rear composition plane of the master compositor arranged behind the front composition plane relative to the line of vision, the master compositor merges the rear composition plane having the graphical infotainment element with the front composition plane having the graphical operating element into the display content in such a way that each graphical element of the front composition plane, in particular the graphical operating element, masks an area of the rear composition plane, in particular of the graphical infotainment element, having an identical position and identical contour, and the master compositor provides the merged display content.

The graphical infotainment element is understood to mean a graphically represented display content of the IVI partition, for example a standard-format video stream with a 16:9 aspect ratio. The master compositor may merge all of its composition planes through a successive superimposition, starting with a rearmost composition plane and ending with the front composition plane. The graphical infotainment element can be generated for its part by an IVI compositor (e.g. surface flinger) by merging a plurality of IVI planes and/or by compositing a plurality of IVI elements within an IVI plane.

The display screen may generate the switchover event as a result of a manual touching by the user of the graphical operating element displayed on the central display screen, and provides the generated switchover event for the system partition. In other words, the maximization of the graphical operating element is assigned to the minimized graphical operating element as the sole function, and the minimization of the operating element is assigned to the maximized graphical operating element as one function of a plurality of functions, i.e. the switchover event initiates a maximization of the minimized graphical operating element or a minimization of the maximized graphical operating element depending on the state. The system partition meets high safety requirements and is available even in the event of a fault in the IVI partition. The user can consequently switch over the state of the graphical operating element at any time during the operation of the information system and, in particular, can initiate the different functions assigned to the maximized operating element.

Alternatively or additionally, the in-vehicle infotainment partition can generate the switchover event as a result of an activation or deactivation of an application of the in-vehicle infotainment partition, in particular an input method editor of the in-vehicle infotainment partition, and a switchover interface arranged between the in-vehicle infotainment partition and the system partition can provide the switchover event generated by the in-vehicle infotainment partition for the system partition. In short, the activation of the application of the in-vehicle infotainment partition can affect the minimization of the graphical operating element, and the deactivation of the application can effect a maximization of the graphical operating element. This may guarantee that the graphical infotainment element associated with the activated application is displayed by the display screen essentially over the entire display screen area or at least in an area of the display screen which is sufficient for the graphical infotainment element, and the minimized graphical operating element is simultaneously displayed.

In an example, the in-vehicle infotainment partition may permanently define an exception area of the display screen having a position and contour identical to the minimized graphical operating element, and may permanently define an output area of the display screen which may be exactly complementary to the exception area for the graphical infotainment element. Due to the exception area, the graphical infotainment element releases the exception area and is consequently not masked by the minimized graphical operating element. In particular, every touch surface assigned to the graphical infotainment element is arranged in the output area and is touchable as an alternative to the minimized graphical operating element. The output area is correspondingly statically defined and configured by the IVI partition.

In an example, the in-vehicle infotainment partition defines an exception area of the display screen having a position and contour identical to the graphical operating element, and an output area of the display screen which may be exactly complementary to the exception area for the graphical infotainment element depending on a state of the graphical operating element. In other words, the output area is dynamically defined and configured by the IVI partition during the operation of the information system.

In an example, the in-vehicle infotainment partition arranges a functionless wildcard element in the rear composition plane which has a position and contour identical to the maximized graphical operating element and which is not masked by any application of the in-vehicle infotainment partition other than an input method editor of the in-vehicle infotainment partition. This means that the input method editor can additionally utilize the display area of the maximized graphical operating element as the sole application of the IVI partition, resulting in a better user experience in relation to the input method editor.

The system partition can initialize the graphical operating element as the maximized graphical operating element, and/or minimizing the graphical operating element or maximizing the graphical operating element can comprise animating the graphical operating element. Following the start-up of the information system, all functions assigned to the graphical operating element can consequently be initiated in the first instance through manual touching. The animation of the graphical operating element can comprise a constant transformation of the graphical operating element between the minimized state and the maximized state, and improves a user experience in relation to the graphical operating element.

In one advantageous example, a graphical control element of a climate control system of the vehicle, in particular a climate control bar of a climate control system operating interface, is displayed as the graphical operating element, and/or an ANDROID operating system is executed in the in-vehicle infotainment partition, and/or the processor subsystem executes a hypervisor virtualizing the processor subsystem, and the hypervisor executed by the processor subsystem executes the system partition and the in-vehicle infotainment partition. The maximized climate control bar (full climate control bar) can be arranged and displayed on a lower edge of the display screen along the entire width of the display screen. The maximized climate control bar can have one or more than one climate control enhancement, in particular two transient climate control enhancements (climate control bar flyouts), which are arranged adjacent to and spaced apart from one another, and which extend from the maximized climate control bar to the upper edge of the display screen. The minimized climate control bar (retracted climate control bar) can be arranged and displayed as a rectangle, in particular as a square, in a left lower corner as part of the maximized climate control bar.

The hypervisor abstracts the processor subsystem and dynamically allocates respectively required or available computing power to the system partition and the IVI partition, as a result of which a function of the system partition and user experience created by the IVI partition are optimized. The hypervisor further prevents the IVI partition from interfering with the system partition, resulting in greater robustness of the functional systems of the vehicle to faults.

The subject-matter of the examples may also be an information system for a vehicle which comprises a system on a chip (SoC) having at least one processor subsystem (CPU), a system partition executable by the processor subsystem, an in-vehicle infotainment (IVI) partition executable by the processor subsystem, and a master compositor which comprises a front composition plane and a rear composition plane, and a touch-sensitive display screen (CID) which is functionally connected to the system on a chip and is arranged centrally in the vehicle. Information systems of this type are installed in a multiplicity of vehicles, thus offering numerous possible uses for the described examples.

The information system according to an example may be configured to carry out a method according to the described examples. The information system operated according to the described examples, on one hand, ensures high availability of functions of the system partition and, on the other hand, allows a pleasant user experience in relation to graphical outputs of the IVI partition. The information system is furthermore simple to implement and operate.

The in-vehicle infotainment partition may comprise an ANDROID operating system. ANDROID operating systems are widespread and have high availability. If the ANDROID operating system is version 4.4 or higher, the output area for the graphical infotainment element can be dynamically configured in runtime.

One significant advantage of the method according to the described examples is that the graphical output of the IVI partition can essentially use the entire display area even without watchdog logic, which is itself prone to faults, resulting in a pleasant user experience. It is further advantageous that a user can electively switch the graphical output of the IVI partition between a use of essentially the entire display area and a display area reduced in favor of a graphical output of the system partition. In addition, a separate display screen for graphical system outputs can be dispensed with, and the size of the central display screen can be reduced.

### BRIEF DESCRIPTION OF THE DRAWINGS

In examples, the invention is shown schematically in the drawings on the basis of examples and described with reference to the drawings, in which figures, identical reference characters each denote functionally identical elements. In the drawings:

FIG. 1 shows a display content of an information system for a vehicle according to the prior art;

FIG. 2 shows a block diagram of an information system for a vehicle according to an example which is operated with a method according to a first example;

FIG. 3 shows a block diagram of the information system shown in FIG. 2 which is operated with a method according to a second example;

FIG. 4 shows a block diagram of the information system shown in FIG. 2 which is operated with a method according to a third example;

FIG. 5 shows a flow diagram of a method for actuating the information system shown in FIGS. 2 to 4;

FIG. 6 shows a flow diagram of a further method for actuating the information system shown in FIGS. 2 to 4.

### DESCRIPTION

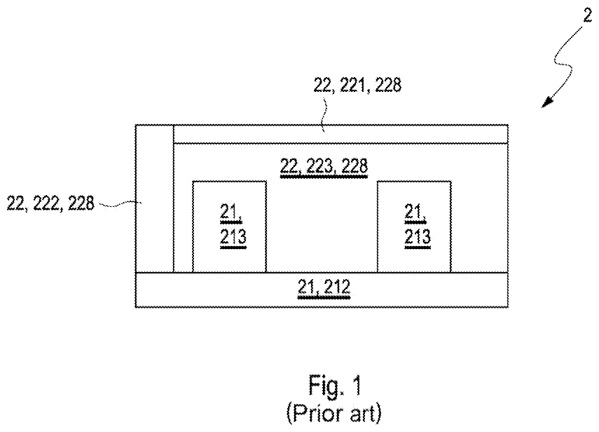

FIG. 1 shows a display content 2 of an information system for a vehicle according to one embodiment of the prior art. The display content 2 comprises a graphical operating element 21 which, as a graphical control element of a climate control system of a vehicle, comprises a climate control bar 212 and two enhancements 213 of the climate control bar 212 which are arranged adjacent to and spaced apart from one another and are assigned, for example, to a right front seat or a left front seat of the vehicle. The climate control bar 212 is arranged in a lower peripheral area of the display content 2 and extends along the entire width of the display content 2. While the climate control bar 212 is permanently displayed, the two enhancements 213 are transient, i.e. are displayed only temporarily.

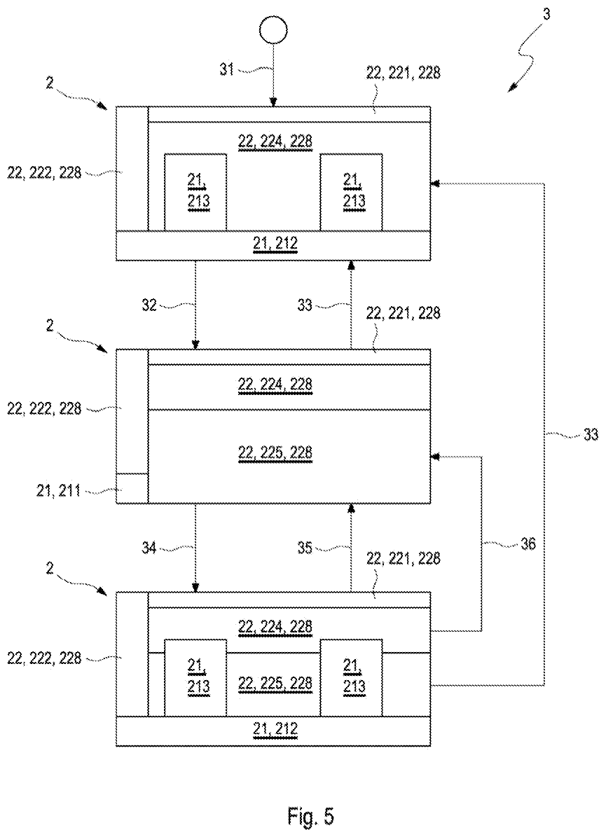

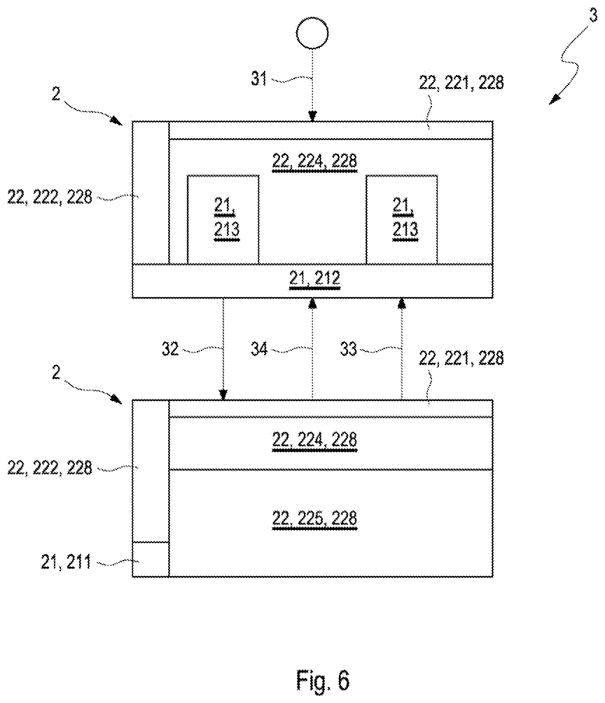

The display content 2 further comprises a graphical infotainment element 22 which comprises a status bar 221, a navigation bar 222 and a climate control enhancement 223. The climate control enhancement 223 provides a plurality of functions of the climate control system, in particular switches, sliders and/or regulators for adjustment, and also a plurality of information elements of the climate control system, in particular operating parameters of the climate control system. Instead of the climate control enhancement 223, a graphical IVI content 224 (see FIGS. 5 and 6) of an infotainment system of the vehicle, for example a web browser or a video stream, can be part of the display content 2.

The climate control enhancement 223 or alternatively the graphical output of the infotainment system can be partially masked by the climate control bar 212 and consequently not completely visible, or can be displayed as reduced, i.e. with a reduced height, and complete. In both cases, a user experience is adversely affected.

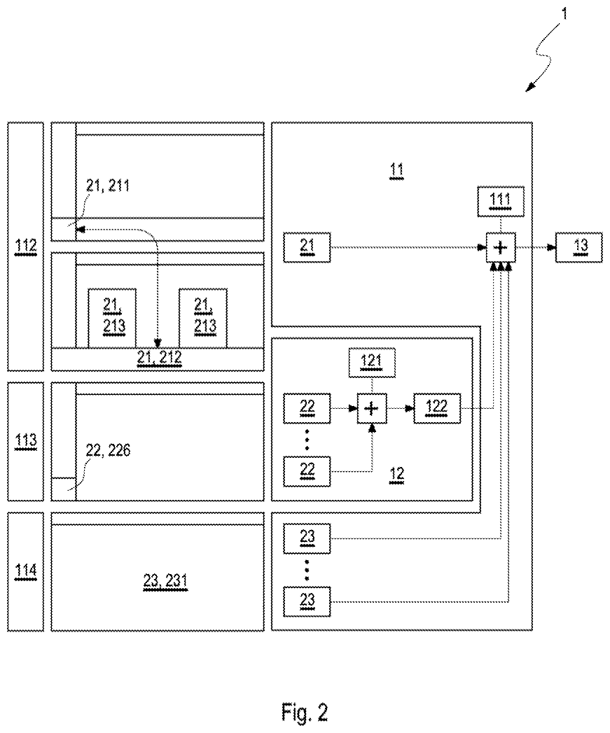

FIG. 2 shows a block diagram of an information system 1 for a vehicle according to an example which is operated with a method according to a first example. The information system 1 comprises a system on a chip (SoC) having at least one processor subsystem (central processing unit, CPU), a system partition 11 executable by the processor subsystem, and an in-vehicle infotainment (IVI) partition 12 executable by the processor subsystem.

The system partition 11 comprises a master compositor (MCP) 111 having a front composition plane 112 relative to a line of vision of a user of the vehicle and a rear composition plane 113 arranged behind the front composition plane 112 relative to the line of vision of the user, and a rearmost composition plane 114. The master compositor 111 can comprise further composition planes. The system partition is configured to generate a graphical operating element 21 and a plurality of graphical system elements 23 and to arrange them in the front composition plane 112 or in the rearmost composition plane 114. The graphical system elements 23 can comprise a graphical background 231.

The in-vehicle infotainment partition 12 comprises an IVI compositor (surface flinger) 121 and a hardware accelerator driver 122, and is configured to generate a graphical infotainment element 22, to merge the graphical infotainment element 22 by way of the IVI compositor 121 and arrange the graphical infotainment element 22 by way of the hardware accelerator driver 122 in the rear composition plane 113.

The system on a chip can comprise a hypervisor which is configured to be executed by the processor subsystem and to execute the system partition 11 and the IVI partition 12.

The information system 1 further comprises a touch-sensitive display screen (center infotainment display, CID) 13 which is functionally connected to the system on a chip and is arranged centrally in the vehicle.

The information system 1 is configured to carry out the following method.

The processor subsystem of the system on a chip of the information system 1 of the vehicle executes the system partition 11 of the system on a chip and the in-vehicle infotainment partition 12 of the system on a chip. If the system on a chip comprises a hypervisor, the processor subsystem executes the hypervisor virtualizing the processor subsystem and the hypervisor executed by the processor subsystem executes the system partition 11 and the in-vehicle infotainment partition 12. An ANDROID operating system, for example an ANDROID operating system at version 4.4 or higher, can be executed in the in-vehicle infotainment partition 12.

A functional system of the system partition 11 generates the graphical operating element 21 and arranges the graphical operating element 21 in the front composition plane 112 of the master compositor 111 of the information system 1. The system partition 11 further generates the graphical background and arranges the graphical background 231 in the rearmost composition plane 114.

An infotainment system of the in-vehicle infotainment partition 12 generates the graphical infotainment element 22 by way of the IVI compositor 121 and the hardware accelerator driver 122, and arranges a graphical infotainment element 22 in the rear composition plane 113 of the master compositor 111.

The master compositor 111 merges the rear composition plane 113 having the graphical infotainment element 22 with the front composition plane 112 having the graphical operating element 21 into the display content 2 in such a way that each graphical element of the front composition plane 112, in particular the graphical operating element 21, masks an area of the rear composition plane 113, in particular of the graphical infotainment element 22, having an identical position and identical contour, and provides the merged display content 2.

The display screen 13 of the information system 1 displays the display content 2 provided by the master compositor 111 and comprising the graphical operating element 21. A graphical control element of a climate control system of the vehicle, in particular a climate control bar 212 of a climate control system operating interface, is shown purely by way of example as the graphical operating element 21.

The display screen 13 generates a switchover event as a result of a manual touching by the user of the graphical operating element 21 displayed on the display screen 13, and provides the generated switchover event for the system partition 11. The system partition 11 minimizes or maximizes the graphical operating element 21, 211, 212 as a result of the switchover event generated outside the system partition 11.

Alternatively or additionally, the in-vehicle infotainment partition 12 can generate the switchover event as a result of an activation or deactivation of an application of the in-vehicle infotainment partition 12, in particular an input method editor (IME) 225 of the in-vehicle infotainment partition 12, and a switchover interface arranged between the in-vehicle infotainment partition 12 and the system partition 11 can provide the switchover event generated by the in-vehicle infotainment partition 12 for the system partition 11.

The in-vehicle infotainment partition 12 permanently defines an exception area 226 of the display screen 13 having a position and contour identical to the minimized graphical operating element 211, and permanently defines an output area 228 of the display screen 13 which is exactly complementary to the exception area 226 for the graphical infotainment element 22, i.e. the exception area 226 and the output area 228 are static and invariable during the operation of the information system 1 and together take up an entire display area of the display screen 13.

Minimizing the graphical operating element 21, 212 or maximizing the graphical operating element 21, 211 can comprise animating, i.e. constantly transforming, the graphical operating element 21. The graphical operating element 21 is initialized as the maximized graphical operating element 212 following an activation of the information system 1.

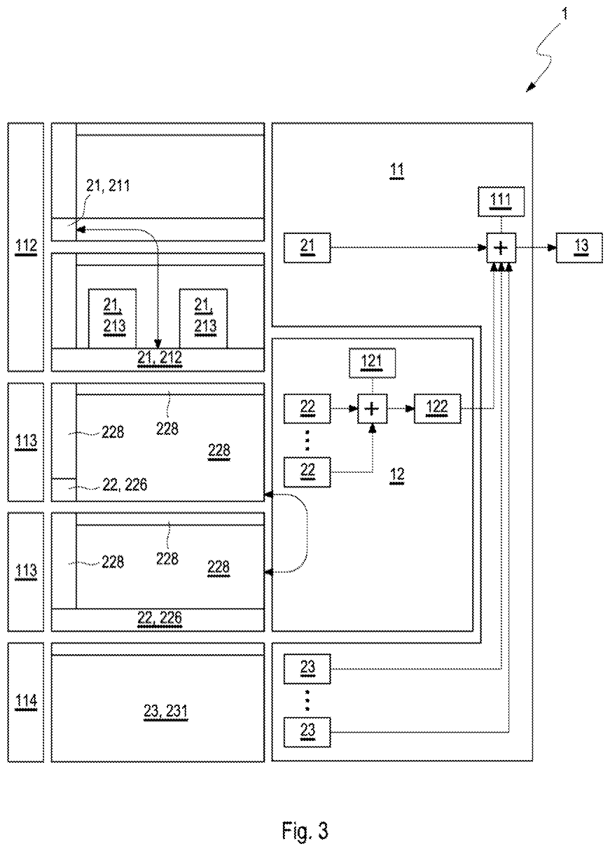

FIG. 3 shows a block diagram of the information system 1 shown in FIG. 2 which is operated with a method according to a second example. The method differs from the method shown in FIG. 2 in that the in-vehicle infotainment partition 12 defines an exception area 226 of the display screen 13 having a position and contour identical to the graphical operating element 21, 211, 212, and defines an output area 228 of the display screen 13 which is exactly complementary to the exception area 226 for the graphical infotainment element 22 depending on a state of the graphical operating element 21, 211, 212. In other words, the exception area 226 and the output area 228 are dynamic and variable during the operation of the information system 1, and together always take up the entire display area of the display screen 13.

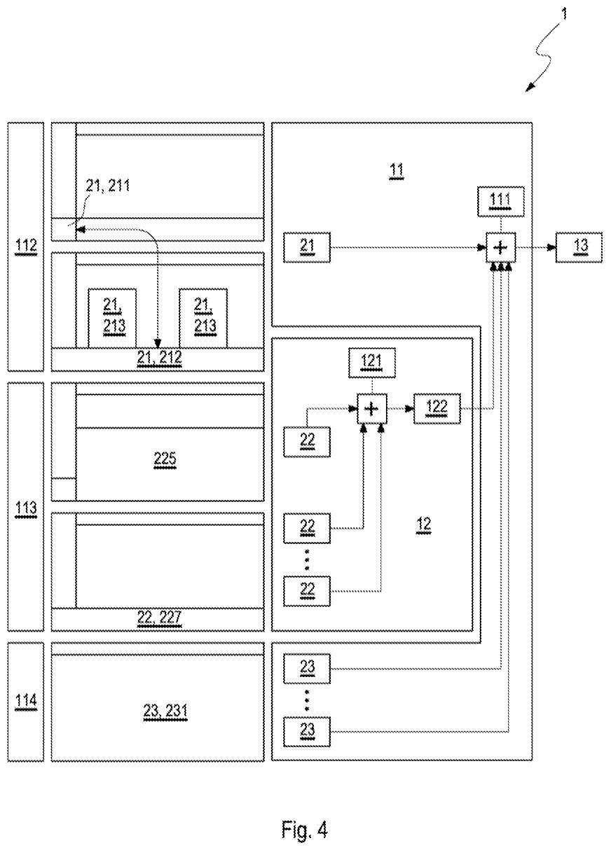

FIG. 4 shows a block diagram of the information system 1 shown in FIG. 2 which is operated with a method according to a third example. The method differs from the method shown in FIGS. 2 and 3 in that the in-vehicle infotainment partition 12 arranges a functionless wildcard element 227 in the rear composition plane 113 which has a position and contour identical to the maximized graphical operating element 212 and which is not masked by any application of the in-vehicle infotainment partition 12 other than the input method editor 225 of the in-vehicle infotainment partition 12. As a result of the relocation of the input method editor 225 into the area of the wildcard element 227, the input method editor 225 can use the area of the maximized graphical 212.

FIG. 5 shows a flow diagram of a method for actuating the information system shown in FIGS. 2 to 4.

The information system has been initialized 31 with the maximized operating element 212. The display content 2 comprises the status bar 221, the navigation bar 222 and a graphical IVI content 224, for example a web browser, which together form the output area 228, and also the graphical operating element 21 which comprises the maximized graphical operating element 212 and the two transient enhancements 213. The input method editor 225 is activated 32 by the user by selecting an input field of the graphical IVI content 224, as a result of which the maximized graphical operating element 212 is minimized. By ending an input into the input field, the user deactivates 33 the input method editor 225, as a result of which the minimized graphical operating elements 211 is maximized. Alternatively, the input method editor 225 is deactivated and the minimized graphical operating element 211 is maximized if the user manually touches 34 the minimized operating element 211.

FIG. 6 shows a flow diagram of a further method for actuating the information system 1 shown in FIGS. 2 to 4. The method differs from the method shown in FIG. 5 in that, as a result of the touching of the minimized graphical operating element 211, the input method editor 225 is deactivated and is not partially masked by the maximized operating element 212.

If the user deactivates the partially masked input method editor 225 by ending an input, the display content 2 is restored following the initializing 31 of the information system 1. Alternatively, the user can minimize the maximized operating element 212 by manually touching 35 the maximized operating element 212 or by manually touching 36 the graphical IVI content 224.

A description has been provided with particular reference to examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

### REFERENCE NUMBER LIST

1 Information system
11 System partition
111 Master compositor
112 Front composition plane
113 Rear composition plane
114 Rearmost composition plane
12 In-vehicle infotainment (IVI) partition
121 IVI compositor
122 Hardware accelerator driver
13 Display screen
2 Display content
21 Graphical operating element
211 Minimized graphical operating element, climate control bar in the minimized state
212 Maximized graphical operating element, climate control bar in the maximized state
213 Transient enhancement of the maximized graphical operating element (climate control bar layout)
22 Graphical infotainment element
221 Status bar
222 Navigation bar
223 Climate control expansion (climate control flyout)
224 Graphical IVI content
225 Input method editor (IME)
226 Exception area
227 Wildcard element
228 Output area
23 Graphical system element
231 Graphical background
3 Actuation method
31 Initialize
32 Activate IME
33 Deactivate IME
34 Manually touch the minimized graphical operating element
35 Manually touch the maximized graphical operating element
36 Manually touch the IVI content

1-10. (canceled)

11. A method of operating an information system of a vehicle, comprising:
executing, by a processor subsystem of a system on a chip (SoC) of the information system of the vehicle, a system partition of the SOC and an in-vehicle infotainment partition (IVI) of the SoC;
generating, by a functional system of the system partition, a graphical operating element and arranging the graphical operating element, in a front composition plane of a master compositor of the information system relative to a line of vision of a user of the vehicle;
displaying, by a touch-sensitive display screen of the information system which is functionally connected to the SoC and is arranged centrally in the vehicle, a display content provided by the master compositor and including the graphical operating element; and
minimizing or maximizing, by the system partition, the graphical operating element as a result of a switchover event generated outside the system partition.

12. The method as claimed in claim 11, in which:
an infotainment system of the (IVI) partition generates a graphical infotainment element and arranges the graphical infotainment element in a rear composition plane of the master compositor arranged behind the front composition plane relative to the line of vision; and
the master compositor merges the rear composition plane having the graphical infotainment element with the front composition plane having the graphical operating element into the display content in such a way that each graphical element of the front composition plane masks an area of the rear composition plane having an identical position and identical contour, and
the master compositor provides the merged display content.

13. The method as claimed in claim 11, in which the touch-sensitive display screen generates the switchover event as a result of a manual touching by the user, of the graphical operating element displayed on the display screen, and provides the generated switchover event for the system partition.

14. The method as claimed in claim 11, in which the IVI partition generates the switchover event as a result of an activation or deactivation of an application of the IVI partition, and a switchover interface arranged between the IVI partition and the system partition provides the switchover event generated by the IVI partition for the system partition.

15. The method as claimed in claim 14, in which the IVI partition permanently defines an exception area of the touch-sensitive display screen having a position and contour identical to a minimized graphical operating element, and permanently defines an output area of the touch-sensitive display screen which is exactly complementary to the exception area for the graphical infotainment element.

16. The method as claimed in claim 14, in which the IVI partition defines an exception area of the touch-sensitive display screen having a position and contour identical to the graphical operating element, and defines an output area of the touch-sensitive display screen which is exactly complementary to the exception area for the graphical infotainment element depending on a state of the graphical operating element.

17. The method as claimed in claim 14, in which the IVI partition arranges a functionless wildcard element in the rear composition plane which has a position and contour identical to a maximized graphical operating element and which is not masked by an application of the IVI partition other than an input method editor of the IVI partition.

18. The method as claimed in claim 11, in which the graphical operating element is initialized as a maximized graphical operating element and/or a minimization of the graphical operating element or a maximization of the graphical operating element comprises animating the graphical operating element.

19. The method as claimed in claim 11, in which,
a graphical control element of a climate control system of the vehicle is displayed as the graphical operating element,
an ANDROID operating system is executed in the IVI partition, and/or
the processor subsystem executes a hypervisor virtualizing the processor subsystem and the hypervisor executed by the processor subsystem executes the system partition and the IVI partition.

20. An information system for a vehicle which comprises a system on a chip (SoC) having at least one processor subsystem, a system partition executable by the processor subsystem, an in-vehicle infotainment (IVI) partition executable by the processor subsystem, a master compositor which comprises a front composition plane and a rear composition plane, and a touch-sensitive display screen which is functionally connected to the SoC and is arranged centrally in the vehicle, which information system is configured to cause execution of a process comprising:
generating, by a functional system of the system partition, a graphical operating element and arranging the graphical operating element, in a front composition plane of the master compositor of the information system relative to a line of vision of a user of the vehicle, master compositor providing a display content including the graphical operating element; and
minimizing or maximizing, by the system partition, the graphical operating element as a result of a switchover event generated outside the system partition.

21. The information system as claimed in claim 20 in which:
an infotainment system of the (IVI) partition generates a graphical infotainment element and arranges the graphical infotainment element in a rear composition plane of the master compositor arranged behind the front composition plane relative to the line of vision; and
the master compositor merges the rear composition plane having the graphical infotainment element with the front composition plane having the graphical operating element into the display content in such a way that each graphical element of the front composition plane masks an area of the rear composition plane having an identical position and identical contour, and
the master compositor provides the merged display content.

22. The information system as claimed in claim 20, in which the touch-sensitive display screen generates the switchover event as a result of a manual touching by the user, of the graphical operating element displayed on the display screen, and provides the generated switchover event for the system partition.

23. The information system as claimed in claim 20, in which the IVI partition generates the switchover event as a result of an activation or deactivation of an application of the IVI partition, and a switchover interface arranged between the IVI partition and the system partition provides the switchover event generated by the IVI partition for the system partition.

24. The information system as claimed in claim 23, in which the IVI partition permanently defines an exception area of the touch-sensitive display screen having a position and contour identical to a minimized graphical operating element, and permanently defines an output area of the touch-sensitive display screen which is exactly complementary to the exception area for the graphical infotainment element.

25. The information system as claimed in claim 23, in which the IVI partition defines an exception area of the touch-sensitive display screen having a position and contour identical to the graphical operating element, and defines an output area of the touch-sensitive display screen which is exactly complementary to the exception area for the graphical infotainment element depending on a state of the graphical operating element.

26. The information system as claimed in claim 23, in which the IVI partition arranges a functionless wildcard element in the rear composition plane which has a position and contour identical to a maximized graphical operating element and which is not masked by an application of the IVI partition other than an input method editor of the IVI partition.

27. The information system as claimed in claim 20, in which the graphical operating element is initialized as a maximized graphical operating element and/or a minimization of the graphical operating element or a maximization of the graphical operating element comprises animating the graphical operating element.

28. The method as claimed in claim 20, in which,
a graphical control element of a climate control system of the vehicle is displayed as the graphical operating element,
an ANDROID operating system is executed in the IVI partition, and/or
the processor subsystem executes a hypervisor virtualizing the processor subsystem and the hypervisor executed by the processor subsystem executes the system partition and the IVI partition.
